(19) United States
(12) Patent Application Publication
(10) Pub. No.: US 2006/0212339 A1
(43) Pub. Date: Sep. 21, 2006

(54) Method of producing a consensus forecast

(76) Inventors: Philip M. Hubbard, London (GB); Che-Wing Pang, Hayes Middlesex (GB); Philip A. Barnes, London (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/083,342

(22) Filed: Mar. 17, 2005

(51) Int. Cl. G07G 1/00

(52) U.S. Cl. 705/10

(57) ABSTRACT

Methods are provided for producing a consensus forecast. An adjusted consensus forecast for a plurality of economic indicators is produced by compensating for forecasters who miss a monthly forecast and by adjusting for unchanged forecasts from the prior monthly survey and by compensating for a lack of dynamism in the forecast values. Where a forecaster misses a forecast, the missing forecast is replaced by the last submitted forecast, for up to three periods following the last submitted forecasts. Unchanged forecasts, whether naturally unchanged or generated by replacement forecasts, are adjusted by taking into account the rate of change of the consensus from the previous monthly survey.

### FIELD OF THE INVENTION

The present invention relates to the field of forecasting, particularly but not exclusively to a method of producing a consensus forecast for a plurality of economic indicators.

### BACKGROUND

Forecasting is used throughout the world by a wide variety of government and private sector organizations as a tool for planning operation in relation to a range of economic and financial indicators. The specific indicators being predicted depend on the measures used in each country. For example, in the US, the indicators may include one or more of Gross Domestic Product (GDP), Personal Consumption, Business Investment, Corporate Profits, Industrial Production, Consumer Prices, Producer Prices, Employment Costs, Auto and Light Truck Sales, Housing Starts, Unemployment Rate, Current Account, Federal Budget Balance, 3 month Treasury Bill Rate, 10 Year Treasury Bond Yield, Foreign Exchange Rates and so on.

A large number of organisations including banks, consultants and large companies provide their own forecasts of particular economic indicators, also referred to as variables. For example, they may provide forecasts for one or more future calendar years of the expected percentage change of GDP and other indicators on the previous calendar year, or forecasts of the Annual Total Current Account in US$bn or forecasts of the 3 month Treasury Bill Rate at the end of a particular period.

It is inevitable that where a large number of different bodies provide forecasts, those forecasts may differ significantly from one another, giving rise to a range or distribution of forecasts. In accordance with general statistical principles, some way of determining a particular representative figure from the distribution is required.

One known way of producing a single figure from the distribution is referred to as the consensus forecast, also referred to herein as the consensus. This is calculated as the simple mean average of a number of independent forecasts, also referred to as the mean.

FIG. 1 illustrates a published set of figures and a consensus forecast for the US for a number of indicators and forecasters.

It has been suggested in a number of academic studies that the mean consensus is more accurate over time than the forecasts of individual forecasters.

However, problems with forecasts remain which have led to a tendency for changes in the mean consensus figures to show serial correlation, in which errors from one period tend to propagate through to successive periods.

The way in which a consensus forecast is arrived at generally is shown in FIG. 2. A consensus survey organisation 1 issues a call to a plurality of forecasters 2, 3, 4 (forecasters A, B, C) requesting that they provide current forecasts for each of a plurality of predetermined indicators or variables. The inventors have determined that a number of problems exist in the way forecasters develop and provide data on which the consensus forecast is based. Tables 1a and 1b below shows an example survey response for a variety of indicators from three forecasters, which is followed by an analysis of the problems this gives rise to.

TABLE 1a
Example forecasts received for the month of January 2005

| | | Consumer | Unemployment | 3 m Treasury |
|---|---|---|---|---|
| Forecaster | GDP | Prices | (%) | Bill Rate (%) |
| A | 4.1 | 2.4 | 5.0 | 2.8 |
| B | 3.9 | 3.0 | 5.2 | 2.5 |
| C | 3.8 | 2.6 | 5.2 | 3.0 |

TABLE 1b
Example Forecasts received for the month of February 2005

| | | Consumer | Unemployment | 3 m Treasury |
|---|---|---|---|---|
| Forecaster | GDP | Prices | (%) | Bill Rate (%) |
| A | 4.7 | 2.5 | 4.8 | 3.0 |
| B | 3.9 | 3.0 | 5.2 | 2.5 |
| C | No response | No response | No response | No response |

In table 1b shown above, forecaster A has produced a set of figures that differ in all cases from the figures for the previous month shown in table 1a. The changed figures are referred to herein as changed forecasts.

In contrast, the figures for forecaster B are identical for both January and February 2005. This suggests that forecaster B is leaving the forecasts static for a period of time. There may be a variety of reasons for this, including inertia, a lack of change in the real economic outlook or scheduling issues. For example, some forecasters revise their forecasts at predetermined times, such as twice a year, and leave the intermediate forecasts unchanged. The unchanged figures are referred to as static forecasts.

The figures for forecaster C show that no figures were submitted for February 2005. This may be because of travel or holiday commitments or because a revised forecast has not been completed or released in time to meet the survey deadline date.

Other factors that are not specifically shown in the tables include forecasters that exhibit a perceived lack of dynamism in adjusting fully or rapidly enough to changed economic circumstances. Some academic studies have concluded that certain forecasters are slow to adjust their published figures.

All of these issues when propagated into the consensus forecasts tend to increase error rates in the consensus figures.

The present invention aims to address these problems.

### SUMMARY OF THE INVENTION

According to the invention, there is provided a method of producing a consensus forecast for an economic indicator for a current period, based on forecast values received from a predetermined number of forecasters, comprising acts of receiving a plurality of forecast values for the indicator, determining if at least one of the forecasters has not provided a forecast value for the current period and, for each of the forecasters that has not provided a forecast value, setting the forecast value to be a value previously received from that forecaster.

Replacing missing forecast values with the last submitted forecast has the potential to reduce error rates in the consensus values. However, to prevent excessive bias in the data set, a limit may be placed on the number of permissible missing periods between the current period and period in which the last value was submitted.

The method may further comprise an act of adjusting the static replacement forecast value in dependence on a change in the consensus from the previous period, for example to take into account the rate of change of the consensus from the previous period.

The method may comprise an act of adjusting the replacement forecast value by an amount by which a consensus value for the indicator for the current period differs from a consensus value for the previous period.

The method may further comprise acts of determining if a forecast value for the current period is unchanged from a forecast value for the previous period and in the event that the value is unchanged, adjusting the value by an amount by which a consensus value for the indicator for the current period differs from a consensus value for the previous period.

The economic indicator may, for example, be any one or more of, although not limited to Gross Domestic Product (GDP), Personal Consumption, Business Investment, Corporate Profits, Industrial Production, Consumer Prices, Producer Prices, Employment Costs, Auto and Light Truck Sales, Housing Starts, Unemployment Rate, Current Account, Federal Budget Balance, 3 month Treasury Bill Rate, 10 Year Treasury Bond Yield and Foreign Exchange Rates.

According to the invention, there is further provided a method of producing a consensus forecast for an economic indicator for a current period, based on forecast values received from a predetermined number of forecasters, comprising acts of receiving a plurality of forecast values for the indicator, adjusting forecast values that are unchanged from the forecast values for the previous period in dependence on a change in the consensus from the previous period.

According to the invention, there is further provided a method of producing a consensus forecast for an economic indicator for a current period, based on forecasts received from a predetermined number of forecasters, comprising acts of receiving a plurality of forecast values for the indicator, for each of the forecasters that has not provided a forecast value, setting the forecast value to be a value previously received from that forecaster, adjusting forecast values that have not changed from the forecast value for the previous period, including values that have been set based on values previously received, in dependence on other received forecast values for the current period and calculating a consensus forecast for the current period, which may comprise an act of calculating the mean of the received forecast values as adjusted.

The method may further comprise an act of calculating a further consensus forecast for the current period by adding a compensating factor to said calculated consensus forecast, said compensating factor compensating for a lack of dynamism in the forecast values.

The compensating factor may comprise an amount by which the consensus value for the current period differs from the consensus value from the previous period multiplied by a weighting factor, the amount being calculated prior to compensating for forecast values that have not been provided and forecast values that are unchanged over successive periods.

### BRIEF DESCRIPTION OF THE DRAWINGS

FIG. 1 is an extract from a publication showing individual economic forecasts from a number of forecasters, as well as the consensus forecast for each indicator;

FIG. 2 illustrates the way in which consensus forecasts are obtained from forecasters;

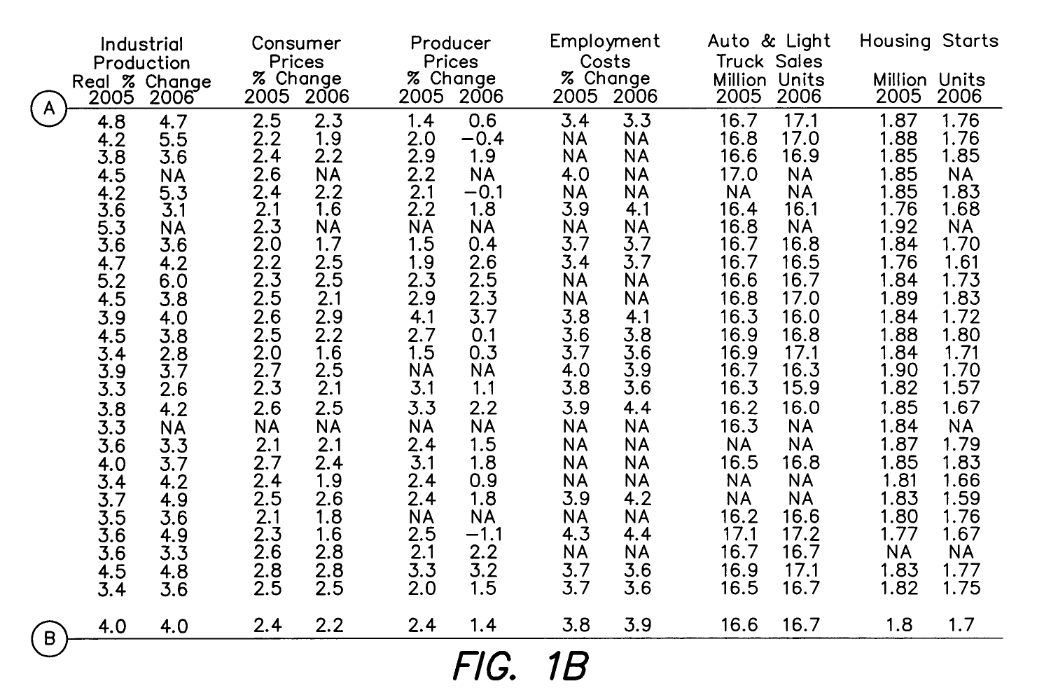

FIG. 3 is a schematic diagram of a computer system capable of running a program according to one embodiment of the invention for performing consensus calculations at a variety of levels;

FIG. 4 is a flow diagram illustrating the Level 3 procedure implemented by the program of FIG. 3 to calculate a Level 3 consensus value;

FIG. 5 is a flow diagram illustrating the Level 4 procedure implemented by the program of FIG. 3 to calculate a Level 4 consensus value; and

FIG. 6 is a flow diagram illustrating the Level 5 procedure implemented by the program of FIG. 3 to calculate a Level 5 consensus value.

### DETAILED DESCRIPTION

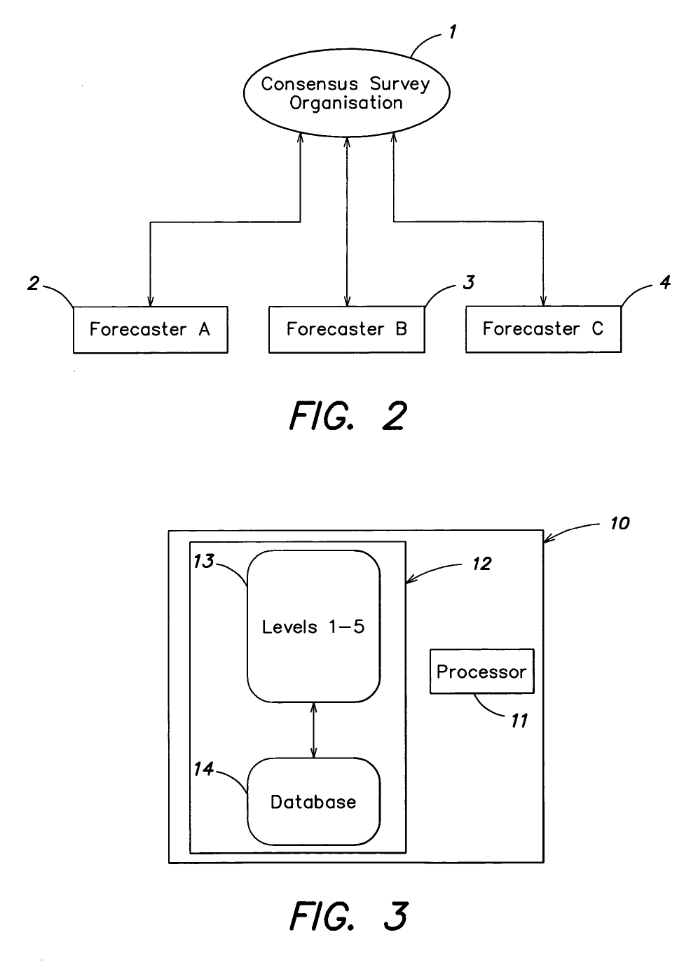

According to various embodiments of the present invention, a number of methods are provided to address problems with the consensus forecasts, which are presented below as processing carried out at a number of levels. FIG. 3 illustrates an example structure of a computer program configured to carry out the processing.

A computer 10, for example an Intel™ processor based machine running a Windows™ operating system comprises a processor 11 and memory 12 for storing the program 13 according to various embodiments of the invention. The computer runs a database application 14 which stores the economic forecasts received from the forecasters. The program according to one embodiment of the invention communicates with the database 14 and operates at a number of levels 1-5, which are described in detail below.

Level 1—Rounded Consensus Figure

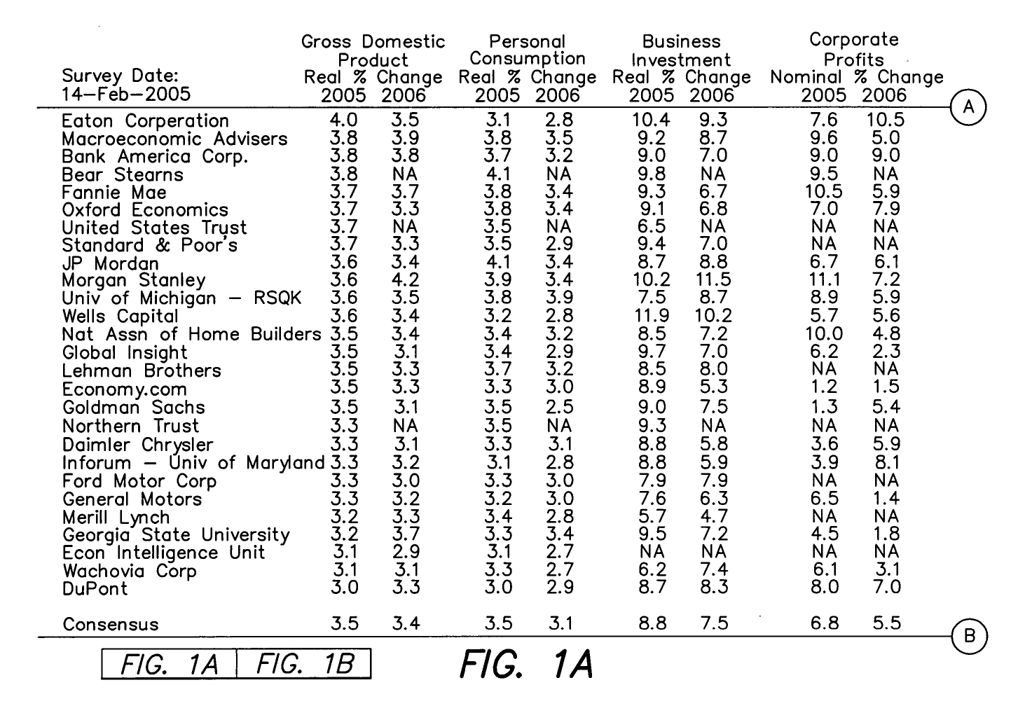

The consensus figure shown in publications such as those illustrated in FIG. 1, which is simply the mean of all the forecast values for a given indicator, is generally provided as a rounded figure, for example rounded to one decimal place. This figure is referred to herein as the Level 1 consensus forecast.

Level 2—Unrounded Consensus Figure

Although presented as a rounded figure at Level 1, the consensus forecast is of course calculated to several decimal places, and more accuracy can be achieved by using a greater number of decimal places or the unrounded calculated figure, which is referred to herein as the Level 2 consensus forecast.

Level 3—Adjusting For Missing Forecasts

The intent at this level is to correct for forecasters who miss a periodic forecast survey. Missing forecasts are adjusted for by replacing the missing forecast value with the last forecast value submitted by the forecaster.

Self-evidently, the more periods that are replaced away from the last known forecast, the greater the bias that is introduced into the resulting data set, because the greater the chance that external economic circumstances have caused the underlying consensus to move away from the forecast figure. Some limit may therefore need to be set on the number of forecasts that can be replaced in this way. In this example, the limit is three.

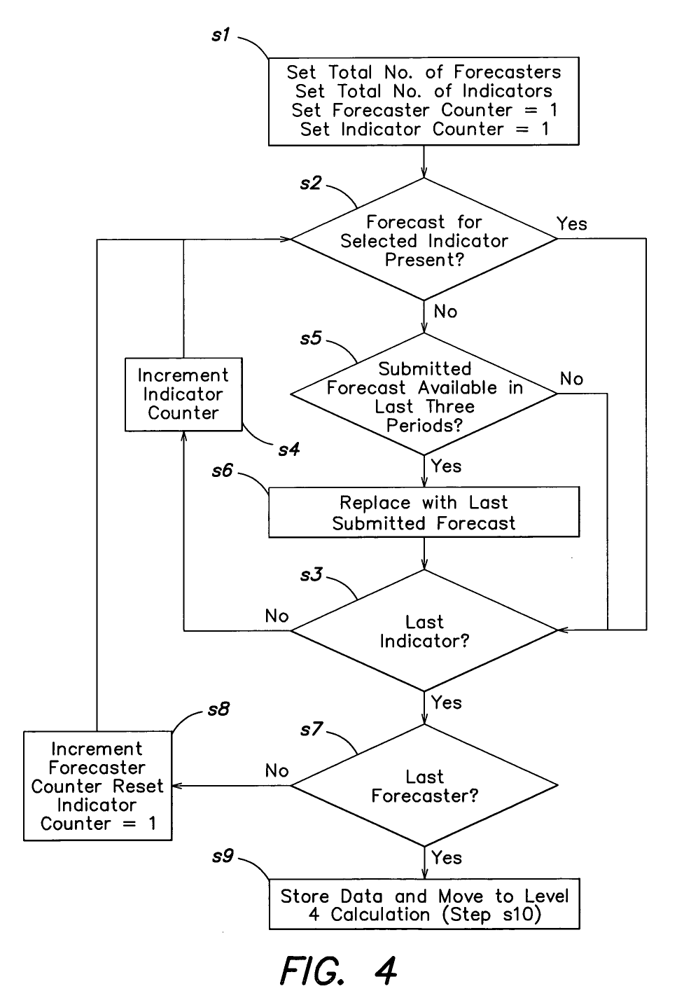

The method implemented by the software to perform the Level 3 replacements is described in more detail with reference to FIG. 4.

The program starts by setting the total number of forecasters and the total number of economic indicators. In addition, a forecaster counter and an economic indicator counter are both set to 1 (step s1). For example, using the example shown in FIG. 1, the initial values of the various variables are:

Total number of forecasters=27

Total number of economic indicators=10

Forecaster counter=1

Indicator counter=1

The program then determines, for the first forecaster and the first economic indicator, whether the forecaster has provided a forecast (step s2). If a value has been provided, no replacement is necessary, and the program then determines whether all of the indicators have been processed (step s3). In this example, there are ten economic indicators, so the last has not been reached. The program therefore increments the indicator counter by 1 (step s4) and looks at the next indicator provided by the first forecaster (step s2). In the event that the forecaster has not provided a forecast for a particular indicator, the program determines whether the forecaster has submitted a forecast for the indicator in any one of the last three periods (step s5). If he has, the missing forecast is replaced with the last submitted forecast (step s6) and the new value stored in the database 14. If not, no replacement is made and the program moves to the next indicator (steps s3, s4).

Once all of the indicators have been processed, the program determines if all of the forecasters have been processed (step s7). If not, the forecaster counter is incremented by one and the indicator counter reset to 1 (step s8). The program then returns to step s2 to look at the first indicator provided by the next forecaster, and so on.

Once the last forecaster has been processed (step s7), the level three calculation is ended and the program can move on to perform the Level 4 calculation (step s9), as described in detail below.

Level 4—Adjusting For Static Forecasts

Static forecasts have been described above as arising from forecasters failing to revise their forecasts each month, but instead leaving them static for months in succession. However, in addition to forecasters failing to revise their forecasts each month, a static forecast can also arise where a previous figure has been inserted for a missing forecast, as described in Level 3 above. In both cases, this can be adjusted for by revising the static forecast up or down by an increment representing the change in the consensus in that particular month.

The adjusted consensus forecast for an indicator for a period m, for example, month m, can therefore be represented as follows:

$${L4}_{m} = \frac{\sum ( {sF}_{m} + ( {C}_{m} - {C}_{m - 1} ) ) + \sum {cF}_{m}}{n}$$

where:
L4ₘ is the adjusted Consensus Forecast at Level 4 for month m
sFₘ is each Forecaster's current Static Forecast, including static forecasts generated at Level 3
cFₘ is each Forecaster's current Changed Forecast
Cₘ-Cₘ₋₁ is the arithmetic change in the Level 2 Consensus since the previous month
n is the total number of static and changed forecasts

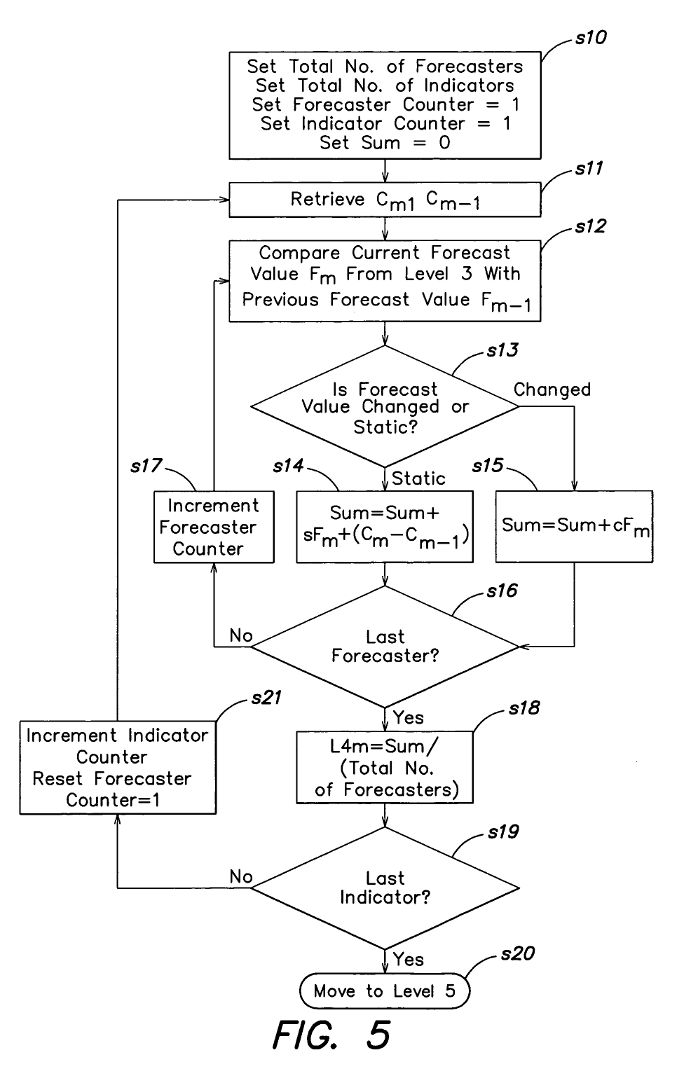

The method implemented by the software to calculate the Level 4 Consensus is described in more detail with reference to FIG. 5.

The Level 4 program first sets the total number of forecasters and the total number of indicators, and initialises the forecaster and indicator counters to 1. In addition it sets an intermediate calculation variable referred to herein as Sum to 0 (step s10). For the first indicator, the program retrieves the Level 2 consensus forecasts Cₘ,

Cₘ₋₁ for the current and previous periods respectively as the mean of the values for all of the forecasters (step s11). The program then compares the current forecast value of each individual forecaster with its forecast value for the previous period, or up to the third previous period if previous period values are missing (step s12), and determines on this basis whether the forecast is static, where the values are the same, or changed, where the values are different (step s13). If the forecast is determined to be static, then the static value is adjusted by the difference between the consensus values for the current and previous periods (Cₘ-Cₘ₋₁), and the adjusted value added to the value in the intermediate variable Sum (step s14). If the forecast is determined to have changed, then this value is added to the intermediate variable Sum (step s15). In either case, the program then determines whether the values provided by all of the forecasters have been processed (step s16). If not, it increments the forecaster counter (step s17) and compares the forecast value provided by the next forecaster (step s12). Once the value for the last forecaster has been processed (step s16), the Level 4 consensus value for the indicator is calculated as the Sum divided by the total number of forecasters (step s18).

The program then determines if all of the indicators have been processed (step s19). If so, the Level 4 data is stored and the program moves on to Level 5 (step s20), otherwise the indicator counter is incremented and the forecaster counter reset to 1 (step s21). The calculation process (steps s11 to s18) is then repeated for the next indicator, so providing an adjusted consensus value for all of the indicators.

Level 5—Adjusting For Lack of Dynamism

The intention of this level is to increase the momentum or rate of change of the consensus to correct for excessive caution on the part of some forecasters in adapting to changed circumstances. For example, a forecaster calculates that an indicator should be changed by a full percentage point to reflect the underlying economic circumstances, but since he considers this to be an overly radical change, in fact only increases the forecast by half a percentage point.

According to the invention, the Level 4 consensus is therefore increased by a further increment by multiplying changes in the Level 2 consensus by a fixed weighting α and adding the product to the Level 4 consensus. A range of weightings, up to and including α=2.5, were found to produce good results for different indicators.

The adjusted consensus forecast for an indicator for a period m, for example, month m, can therefore be represented as follows:
L5ₘ=L4ₘ+α(Cₘ-Cₘ₋₁)
where:
L5ₘ is the adjusted Consensus Forecast at Level 5 for month m
L4ₘ is the adjusted Consensus Forecast at Level 4 for month m
Cₘ-Cₘ₋₁ is the change in the Level 2 Consensus since the previous month
α a is a weighting factor

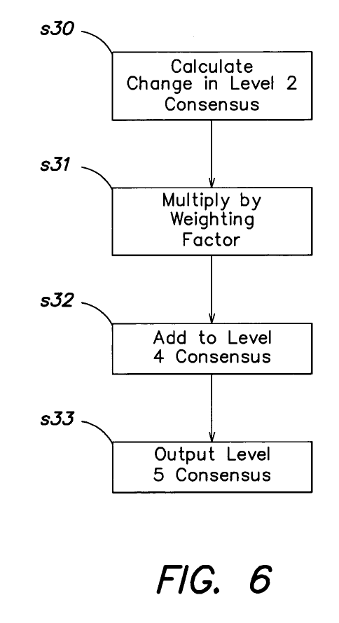

The method implemented by the software to calculate the Level 5 Consensus for a given indicator is described in more detail with reference to FIG. 6.

The program first calculates the change in the Level 2 Consensus since the previous month by subtracting the Level 2 consensus figure for the previous month from the Level 2 consensus figure for the current month (step s30). This figure is then multiplied by the selected weighting factor (step s31), and the product is added to the Level 4 Consensus (step s32). This results in the Level 5 consensus figure being produced (step s33).

The example program discussed above was tested on data from a large number of countries, including the G7 countries (United States, Japan, Germany, France, United Kingdom, Italy and Canada), and a wide variety of indicators, including GDP, Personal Consumption, Industrial Production and Inflation. On average, the program showed significant improvement for Mean Absolute Error (MAE) and Root Mean Squared Error (RMSE) tests for the above indicators when compared with Level 2 consensus figures. However, the methods described above are not limited in application to the specific indicators or countries mentioned, but are applicable for calculating consensus values for all types of economic and financial indicators used across the world.

In the above described embodiment, the consensus has been described as being calculated as the simple mean average of a number of independent forecasts. However, it will be apparent that other methods of calculating the consensus can be used in appropriate circumstances. In general terms, the consensus can be calculated in any suitable way that results in a single figure that is representative of the underlying forecasts. For example, the consensus value may be the median of the underlying forecasts. Alternatively, the consensus may be calculated as a weighted average of the underlying forecasts. In this case, the particular weightings given to different forecast values may vary. For example, weight may only be given to changed and not static forecasts in the calculation of Cₘ and Cₘ₋₁. Alternatively, progressively more weight could be given to forecasts that have changed recently, and less to those changed several periods ago. In a further alternative, more weight could be given to forecasters whose forecasts had proved more accurate in prior years. The invention is not limited by the particular way in which the consensus values are calculated.

It will be understood that while the examples have generally discussed periods in terms of months, the invention applies to any period over which successive forecasts are made, whether this is in terms of days, weeks, quarters or otherwise.

It will further be understood that while specific methods of performing the calculations have been disclosed by reference to the flow charts in FIGS. 4, 5 and 6, a person skilled in the art would be able to implement the calculations required in numerous different ways in any appropriate computer language.

What is claimed is:

1. A method of producing a consensus forecast for an economic indicator for a current period, based on forecast values received from a predetermined number of forecasters, comprising acts of:
receiving a plurality of forecast values for the indicator;
determining if at least one of the forecasters has not provided a forecast value for the current period; and
for each of the forecasters that has not provided a forecast value, setting the forecast value to be a value previously received from that forecaster.

2. A method according to claim 1, comprising an act of setting the forecast value to a previously received value only if the previously received value was received within a predetermined number of periods before the current period.

3. A method according to claim 2, wherein the predetermined number of periods comprises three periods before the current period.

4. A method according to claim 1, further comprising an act of adjusting the set forecast value in dependence on a change in the consensus from the previous period.

5. A method according to claim 4, comprising an act of adjusting the set forecast value by an amount by which a consensus value for the indicator for the current period differs from a consensus value for the previous period.

6. A method according to claim 1, further comprising acts of:
determining if a forecast value for the current period is unchanged from a forecast value for the previous period; and
in the event that the value is unchanged, adjusting the value by an amount by which a consensus value for the indicator for the current period differs from a consensus value for the previous period.

7. A method according to claim 1, wherein the economic indicator is at least one indicator selected from the group comprising Gross Domestic Product (GDP), Personal Consumption, Business Investment, Corporate Profits, Industrial Production, Consumer Prices, Producer Prices, Employment Costs, Auto and Light Truck Sales, Housing Starts, Unemployment Rate, Current Account, Federal Budget Balance, 3 month Treasury Bill Rate, 10 Year Treasury Bond Yield and Foreign Exchange Rates.

8. A method of producing a consensus forecast for an economic indicator for a current period, based on forecast values received from a predetermined number of forecasters, comprising acts of:
receiving a plurality of forecast values for the indicator; and
adjusting forecast values that are unchanged from the forecast values for the previous period in dependence on a change in the consensus from the previous period.

9. A method according to claim 8, comprising an act of adjusting the unchanged forecast values by an amount by which a consensus value for the indicator for the current period differs from a consensus value for the previous period.

10. A method according to claim 8, wherein the economic indicator is at least one indicator selected from the group comprising Gross Domestic Product (GDP), Personal Consumption, Business Investment, Corporate Profits, Industrial Production, Consumer Prices, Producer Prices, Employment Costs, Auto and Light Truck Sales, Housing Starts, Unemployment Rate, Current Account, Federal Budget Balance, 3 month Treasury Bill Rate, 10 Year Treasury Bond Yield and Foreign Exchange Rates.

11. A method of producing a consensus forecast for an economic indicator for a current period, based on forecasts received from a predetermined number of forecasters, comprising acts of:
receiving a plurality of forecast values for the indicator;
for each of the forecasters that has not provided a forecast value, setting the forecast value to be a value previously received from that forecaster;
adjusting forecast values that have not changed from the forecast value for the previous period, including values that have been set based on values previously received, in dependence on a change in the consensus from the previous period; and
calculating a consensus forecast for the current period.

12. A method according to claim 11, wherein the act of calculating a consensus forecast for the current period comprises an act of calculating the mean of the received forecast values as adjusted.

13. A method according to claim 11, wherein the act of calculating a consensus forecast for the current period comprises an act of calculating a weighted average of the received forecast values as adjusted.

14. A method according to claim 13, comprising an act of giving values that are based on previously received values a weighting that depends on when the previously received value was received.

15. A method according to claim 14, comprising an act of giving values that are more recently received greater weight.

16. A method according to claim 13, comprising an act of only giving a weighting to values that have changed from a previous period.

17. A method according to claim 13, comprising an act of giving greater weight to values received from forecasters whose forecasts had proved more accurate in prior years.

18. A method according to claim 11, wherein the act of adjusting the forecast values that have not changed comprises an act of changing said forecast values by an amount by which a consensus value for the current period differs from a consensus value for the previous period.

19. A method according to claim 18, further comprising an act of calculating a further consensus forecast for the current period, the act of calculating including an act of adding a compensating factor to said calculated consensus forecast, said compensating factor compensating for a lack of dynamism in the forecast values.

20. A method according to claim 19, wherein the compensating factor comprises an amount by which the consensus value for the current period differs from the consensus value from the previous period multiplied by a weighting factor, the amount being calculated prior to compensating for forecast values that have not been provided and forecast values that are unchanged over successive periods.

21. A method according to claim 20, wherein the weighting factor is in a range from 0 to 2.5 depending on the indicator.
